(19) United States
(12) Patent Application Publication
(10) Pub. No.: US 2018/0100485 A1
(43) Pub. Date: Apr. 12, 2018

(54) Wind Energy Device

(71) Applicant: Sentauris Pty Ltd, Baldivis (AU)

(72) Inventors: Terrie Kelly, Baldivis (AU); Edward Joseph Khoury, Bateman (AU)

(21) Appl. No.: 15/730,654

(22) Filed: Oct. 11, 2017

(30) Foreign Application Priority Data
Oct. 11, 2016 (AU) 2016904126

(51) Int. Cl. F03D 3/06

(52) U.S. Cl. CPC F03D 3/064; F03D 3/005; F03D 3/065

(57) ABSTRACT

A wind energy device (10) comprising a plurality of curved blades (14) mounted for rotation about a vertical rotational axis (13). Each of the blades (14) includes a linear inner edge (16), an outer edge (17) and upper and lower edges (18 and 19). The inner edges (16) of each of the blades (14) are located adjacent and parallel to the rotational axis (13) and the upper and lower edges (18, 19) are tapered from adjacent the inner edge (16) such that outer edges (19) of the blades (14) are shorter than the inner edges (16).

### FIELD OF THE INVENTION

The present invention relates to a wind energy device.

### BACKGROUND TO THE INVENTION

Wind energy devices comprising roof mounted turbines may be used for energy generation in appropriate locations. Such turbines may comprise horizontal or vertical axis devices. Vertical axis devices generally comprise a number of curved blades mounted for rotation about a vertical axis. Such devices have an advantage over horizontal axis devices in that they do not need to be pointed into the wind. Vertical axis devices generally though comprise relatively tall structures, which can detract from their appearance on a residential building.

The present invention relates to a wind energy device being a vertical axis turbine having features aimed at improving the appearance of the device and/or allowing the device to be constructed in a simple and cost effective manner.

### SUMMARY OF THE INVENTION

According to one aspect of the present invention there is provided a wind energy device comprising a plurality of curved blades mounted for rotation about a vertical rotational axis, each of the blades including a linear inner edge, an outer edge and upper and lower edges joining opposed ends of the inner and outer edges wherein the inner edges of each of the blades are located adjacent and parallel to the rotational axis and the upper and lower edges are tapered from adjacent the inner edge such that outer edges of the blades are shorter than the inner edges.

Preferably upper and lower edges of the blade are generally linear such that the height of the blade decreases continuously from the inner edges to the outer edges thereof.

Preferably the outer edges are liner and oriented parallel to the rotational axis.

Preferably the blades are secured between an upper plate and a lower plate, wherein portions of the upper and lower edges of the blades adjacent the inner edges are secured to the upper and lower plates respectively.

In one embodiment, the upper and lower edges of each of the blades include a plurality of transverse tabs adjacent the inner edges thereof, the tabs extending horizontally and each including a hole for receiving a fastener for securing the blade to the upper or lower plate.

Preferably the lower plate is secured a rotor provided within a rotor housing.

In a preferred embodiment, the rotor housing is a cylindrical housing having an open upper end and a closed lower end and wherein the rotor is mounted for rotation about a vertical shaft extending outwardly through a hole in the closed lower end of the rotor housing.

Preferably lower edges of the blades include recessed portions adjacent the inner edges thereof for receiving a portion of the rotor housing.

Preferably the recessed portions include horizontal edge portion extending adjacent to an upper surface of the rotor housing and a vertical edge portion extending downwardly adjacent an outer surface of the rotor housing.

Preferably one or more securing rings extend around the blades and engage adjacent outer edges of the blades to provide rigidity to the blades.

In a preferred embodiment, each of the blades comprises a concave face for receiving wind and an opposed convex face and wherein the securing rings are secured to the convex face adjacent the outer edges blade.

Preferably securing clips are provided to receive the securing rings and to be engaged to the convex surface of the blade.

Preferably the blades are provided with ridges extending horizontally from the inner edges to the outer edges thereof.

### BRIEF DESCRIPTION OF THE DRAWINGS

The invention will now be described, by way of example, with reference to the following drawings in which:

FIG. 1 is a first upper perspective view of a wind energy device in accordance with the present invention;

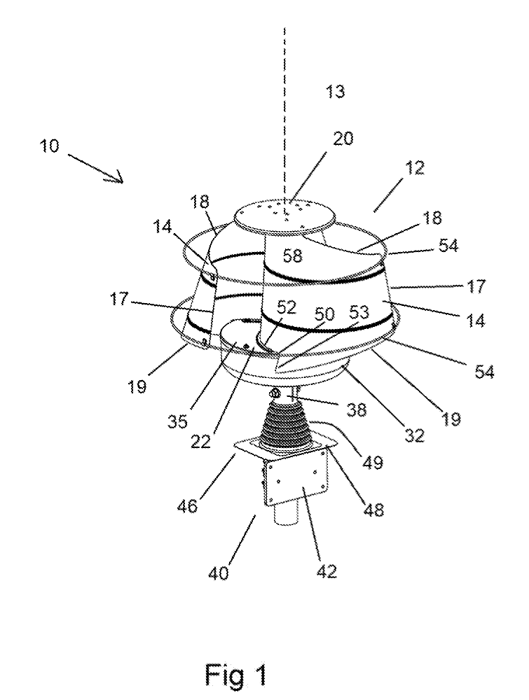

FIG. 2 is a second upper perspective view of the wind energy device of FIG. 1;

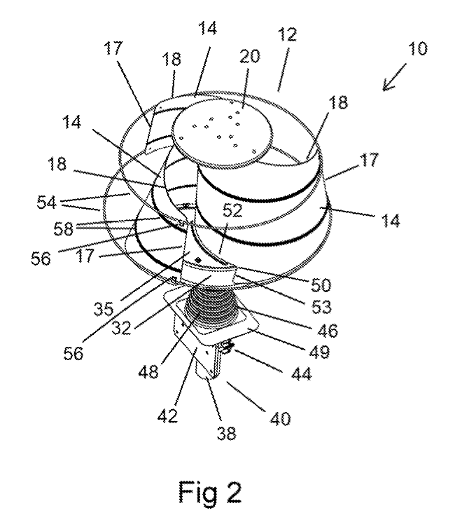

FIG. 3 is a view of the wind energy device of FIG. 1 removed from its mounting assembly;

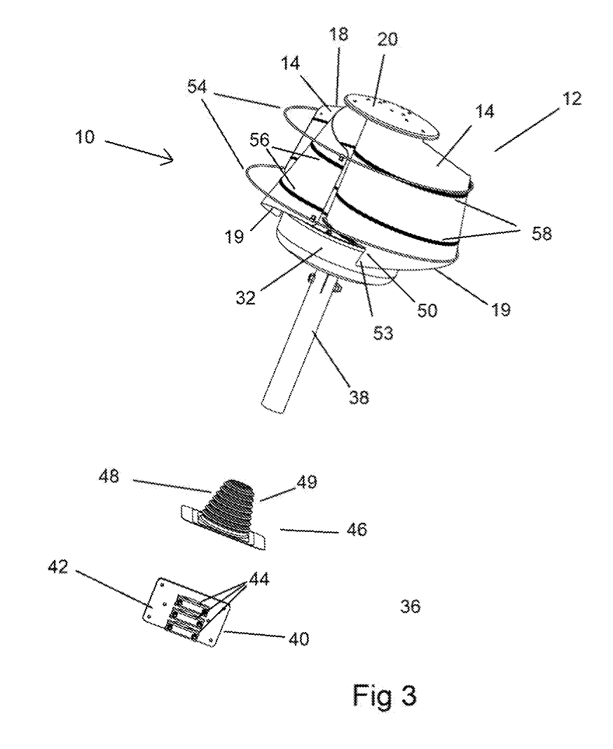

FIG. 4 is an exploded view of the wind energy device of FIG. 1;

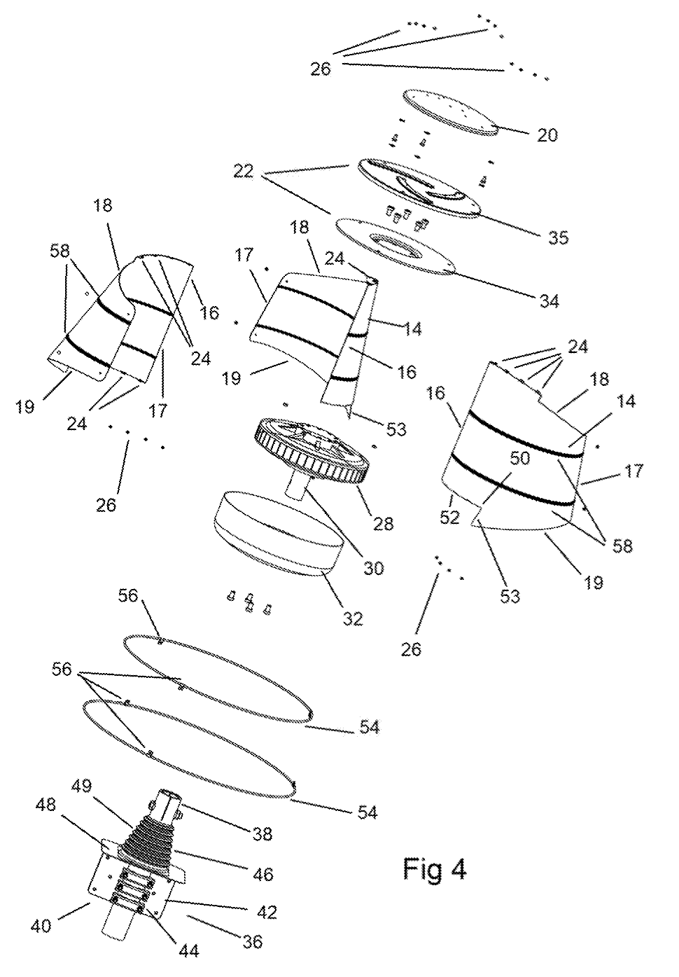

FIG. 5 is a view of the wind energy device of FIG. 1 mounted on a roof; and

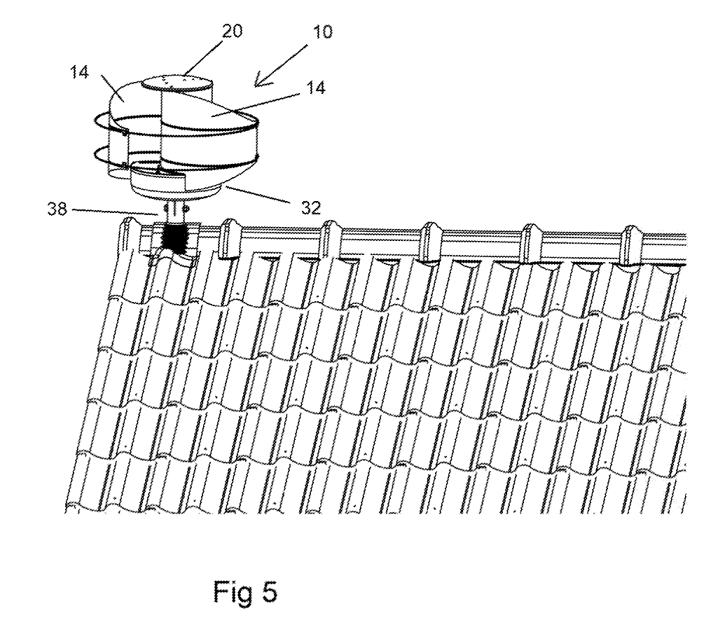

FIG. 6 shows an alternative embodiment of a wind energy device in accordance with the present invention;

### DETAILED DESCRIPTION OF PREFERRED EMBODIMENTS

Referring to the Figures, there is shown a wind energy device 10 comprising a turbine 12 mounted for rotation about a vertical rotational axis 13. The turbine 12 comprises a plurality of blades 14. In the embodiment shown there are provided three such blades 14.

Each of the blades 14 comprises a curved sheet of a suitable material having an inner edge 16 and an outer edge 17. The inner and outer edges 16 and 17 are connected at upper ends thereof by an upper edge 18 and at lower ends thereof by a lower edge 19. The inner edges 16 of the blades 14 are linear in the embodiment shown and are oriented vertically and located adjacent the rotational axis 13. The outer edges 17 of the blades 14 are also linear and oriented parallel to the rotational axis 13. The blades 14 are located at equal angular spacings around the rotational axis 13. Concave faces of the blades 14 are provided to be acted upon by the flow of air to cause rotation of the turbine 12 about the rotational axis 13 in a known manner.

The blades 14 are secured between an upper plate 20 and a lower plate 22. A portion of the upper edge 18 of each of the blades 14 is secured to the upper plate 20 adjacent the inner edge 16. A portion of the lower edge 19 adjacent the inner edge 16 of each of the blades 14 is secured to the lower plate 22. In the embodiment shown, the upper and lower plates 20 and 22 are circular.

The upper and lower edges 18 and 19 of each of the blades 14 include a plurality of transverse tabs 24 adjacent the inner edges 16 thereof. Each of the tabs 24 extends generally horizontally and includes a hole for receiving a fastener 26 for securing the blade 14 to the upper and lower plates 20 and 22. The tabs 24 extend along a portion of the upper and lower edges 18 and 19 adjacent the inner edges 16 of the blades 14.

The lower plate 22 is secured to a rotor 28 mounted for rotation about the vertical rotational axis 13. The rotor 28 is mounted for rotation about a shaft 30 to be mounted vertically in use. A rotor housing 32 is provided for receiving the rotor 28 such that the rotor housing 32 encases the vertical and lower sides of the rotor 28. The rotor housing 32 comprises a cylindrical housing having a closed lower end and an open upper end.

The closed lower end of the rotor housing 32 includes an opening through which is received the shaft 30 and an upper surface of the rotor 28 is exposed through the open upper end of the rotor housing 32. The closed lower end of the rotor housing 32 includes an opening through which is received the shaft 30.

The lower plate 22 comprises a first disc 34 secured to an upper surface of the rotor 28 and a second disc 35 secured to the upper surface of the first disc 34. The lower edges 19 of the blades 14 are secured to the upper surface of the second disc 35.

The turbine 12 is secured to a mounting assembly 36 which is to be secured to a roof of a structure. The mounting assembly 36 includes a pole 38 having an open upper end into which is received a lower end of the shaft 30.

A mounting bracket 40 is provided to be secured to an element of the roof structure, such as a roof beam, and comprises a mounting plate 42 and a plurality of clamps 44. The mounting plate 42 may be secured to the roof beam by appropriate fasteners. The clamps 44 comprise U-shaped clamps having holes at opposed ends for receiving threaded fasteners which engage also through the mounting plate 42. A lower end of the pole 38 is received between the clamps 44 and the mounting plate 42 and adjusted vertically for the desired height of the turbine 12. The fasteners are tightened through the clamps 44 to engage the pole 38 between the clamps 44 and the mounting plate 42.

A flexible boot 46 is provided to seal around the pole 38. The boot 46 includes a planar base portion 48 and a frustoconical upper portion 49. The upper portion 49 receives the pole 38 and includes a concertina shaped outer surface for flexibility.

The blades 14 of the turbine 12 are tapered such that the outer edges 17 of the blades 14 are shorter than the inner edges 16. The upper and lower edges 18 and 19 are generally linear in the embodiment shown such that the height of the blade 14 decreases continuously from adjacent the inner edge 16 to the outer edge 17 thereof.

The lower edges 19 of the blades 14 include recessed portions 50 adjacent the inner edges 16 thereof for receiving a portion of the rotor housing 32. The recessed portions 50 include a horizontal edge portion 52 to extend adjacent to an upper surface of the lower plate 22 and a vertical edge portion 53 provided to extend downwardly adjacent an outer surface of the rotor housing 32. The horizontal edge portion 52 extends horizontally from the inner edge 16 of the blade 14 and the vertical edge portion 52 extends downwardly from the end of the horizontal edge portion 52 remote from the inner edge 16 of the blade.

The upper edges 18 of the blades 14 extend downwardly from adjacent the inner edge 16 to the outer edge 17. The upper edges 18 are generally linear from adjacent the inner edge 16 to the outer edge 17. The lower edges 19 of blades 14 extend upwardly from the end of the recessed portions 50 to the outer edges 17 thereof. The lower edges 19 are generally linear from the end of the recessed portions 50 to the outer edges 17.

The tapered shape of the blades 14 and the recessed portions 50 to receive the rotor housing 32 provide the wind energy device 10 with a more streamlined appearance, thereby improving the aesthetics of the wind energy device 10 when mounted on a roof.

The blades 14 are provided also with one or more securing rings 54. Each of the securing rings 54 comprises a circular member formed from an elongate wire. In the embodiment shown, there are provided two such securing rings 54. The securing rings 54 extend around the periphery of the blades 14 and engage with each of the blades 14 adjacent the outer edge 17 thereof. The securing rings 54 are secured to the convex surface of each of the blades 14 adjacent the outer edge 17 thereof.

Securing clips 56 are provided to receive the securing rings 54 and to be engaged to the convex surface of the blade 14. The securing rings 14 thereby provide additional stiffening to the blades 14.

The blades 14 are also provided with ridges 58 for additional stiffening. The ridges 58 extend horizontally from the inner edges 16 of the blades 14 to the outer edges 17 thereof. In the embodiment shown, there are provided two such ridges 58, one adjacent each of the securing rings 14.

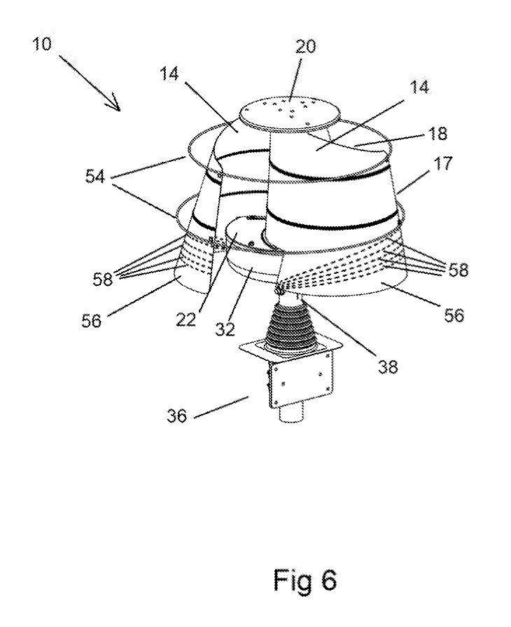

FIG. 6 shows a second embodiment of a wind energy device 10 in accordance with the present invention. The wind energy device 10 of FIG. 6 is similar to the previous embodiment and like reference numerals are used to denote like parts. The blades 14 of the wind energy device include a plurality of breakaway sections 58 extending outwardly from the lower edge 19. Each of the breakaway sections 56 is defined by a perforated line 58 extending from a lower end of the vertical edge portion 53 to the outer edge 17 of the blade 14. The perforated lines 58 are provided at a plurality of angles to the horizontal and one or more of the breakaway sections 56 can be removed by separating the blade 14 at the desired perforated line 58. The upward angle of the lower edge 19 of the blade 14 can therefore be selected as required.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A wind energy device comprising:
a plurality of curved blades mounted for rotation about a vertical rotational axis, each of the blades including a linear inner edge, an outer edge and upper and lower edges joining opposed ends of the inner and outer edges, wherein the inner edges of each of the blades are located adjacent and parallel to the rotational axis, and the upper and lower edges are tapered from adjacent the inner edge such that outer edges of the blades are shorter than the inner edges.

15. The wind energy device in accordance with claim 14, wherein upper and lower edges of the blade are generally linear such that the height of the blade decreases continuously from the inner edges to the outer edges thereof.

16. The wind energy device in accordance with claim 15, wherein the outer edges are linear and oriented parallel to the rotational axis.

17. The wind energy device in accordance with claim 16, wherein the blades are secured between an upper plate and a lower plate, and wherein portions of the upper and lower edges of the blades adjacent the inner edges are secured to the upper and lower plates, respectively.

18. The wind energy device in accordance with claim 17, wherein the upper and lower edges of each of the blades include a plurality of transverse tabs adjacent the inner edges thereof, the tabs extending horizontally and each including a hole for receiving a fastener for securing the blade to the upper or lower plate.

19. The wind energy device in accordance with claim 18, wherein the lower plate is secured to a rotor provided within a rotor housing.

20. The wind energy device in accordance with claim 19, wherein the rotor housing is a cylindrical housing having an open upper end and a closed lower end, and wherein the rotor is mounted for rotation about a vertical shaft extending outwardly through a hole in the closed lower end of the rotor housing.

21. The wind energy device in accordance with claim 20, wherein lower edges of the blades include recessed portions adjacent the inner edges thereof for receiving a portion of the rotor housing.

22. The wind energy device in accordance with claim 21, wherein the recessed portions include a horizontal edge portion extending adjacent to an upper surface of the rotor housing and a vertical edge portion extending downwardly adjacent an outer surface of the rotor housing.

23. The wind energy device in accordance with claim 22, wherein one or more securing rings extend around the blades and engage adjacent outer edges of the blades to provide rigidity to the blades.

24. The wind energy device in accordance with claim 23, wherein each of the blades comprises a concave face for receiving wind and an opposed convex face, and wherein the securing rings are secured to the convex face adjacent the outer edges blade.

25. The wind energy device in accordance with claim 24, wherein securing clips are provided to receive the securing rings and to be engaged to the convex surface of the blade.

26. The wind energy device in accordance with claim 25, wherein the blades are provided with ridges extending horizontally from the inner edges to the outer edges thereof.

27. The wind energy device in accordance with claim 14, wherein one or more securing rings extend around the blades and engage adjacent outer edges of the blades to provide rigidity to the blades.

28. The wind energy device in accordance with claim 14, wherein the blades are provided with ridges extending horizontally from the inner edges to the outer edges thereof.

29. The wind energy device in accordance with claim 17, wherein the lower plate is secured to a rotor provided within a rotor housing.

30. The wind energy device in accordance with claim 19, wherein lower edges of the blades include recessed portions adjacent the inner edges thereof for receiving a portion of the rotor housing.
